(19) United States
(12) Patent Application Publication
(10) Pub. No.: US 2026/0020579 A1
(43) Pub. Date: Jan. 22, 2026

(54) Culinary Smoker

(71) Applicant: Michael Leonardo Nitti, Mooroolbark (AU)

(72) Inventor: Michael Leonardo Nitti, Mooroolbark (AU)

(21) Appl. No.: 19/269,831

(22) Filed: Jul. 15, 2025

Related U.S. Application Data
(60) Provisional application No. 63/672,861, filed on Jul. 18, 2024.

(51) Int. Cl. A23B 4/052

(52) U.S. Cl. CPC A23B 4/0523

(57) ABSTRACT

A culinary smoker for imparting smoke flavor to food and beverage items from a flammable material has a base having a support surface extending to a perimeter, and a dome configured to cover part of the base and form at least a partial seal therewith. The dome includes a top portion and a downwardly extending sidewall terminating at a lower edge for contacting the base, and a dome aperture through the dome. A chimney assembly is mounted to the dome and has a mounting plate which includes a plate aperture, the mounting plate being mounted over the dome aperture. The chimney assembly further includes a chimney housing with a tubular body that extends through the plate aperture, wherein the chimney housing has at least one screen for supporting the flammable material and allowing smoke to pass therethrough to an interior of the dome.

### CROSS-REFERENCE TO RELATED APPLICATIONS

This application for a utility patent claims the benefit of U.S. Provisional Application No. 63/672,861, filed Jul. 18, 2024.

### BACKGROUND OF THE INVENTION

### Field of the Invention

The present invention pertains to culinary devices, and more particularly to a culinary smoker adapted to impart smoke flavor to food and beverage items.

### Description of Related Art

Traditional smoking methods usually involve cumbersome setups and are not suited for quick or efficient flavoring of individual servings. Prior art reveals various devices aimed at smoking foods and beverages; however, these devices often lack the convenience, efficiency, and versatility required for home or professional use. There exists a need for a compact, efficient, and user-friendly device capable of adding smoke flavor to a variety of items without the complexity and size of traditional smoking equipment. The present invention fulfills these needs and provides further advantages as described in the following summary.

### SUMMARY OF THE INVENTION

The present invention teaches certain benefits in construction and use which give rise to the objectives described below.

The present invention provides a culinary smoker for imparting smoke flavor to food and beverage items from a flammable material. The culinary smoker comprises a base having a support surface extending to a perimeter, and a dome configured to cover part of the base and form at least a partial seal therewith. The dome includes a top portion and a downwardly extending sidewall terminating at a lower edge for contacting the base, and a dome aperture through the dome. A chimney assembly is mounted to the dome and includes a chimney housing with a tubular body that includes a screen for supporting the flammable material and allowing smoke to pass therethrough to an interior of the dome.

A primary objective of the present invention is to provide a culinary smoker having advantages not taught by the prior art.

Another objective is to provide a culinary smoker having a unique chimney assembly for efficient and effective smoking of food/beverages.

Another objective is to provide a culinary smoker that is convenient to use and easy to clean.

A further objective is to provide a culinary smoker that is effective in smoking foods items quickly, easily, and to taste.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a perspective view of a culinary smoker according to one embodiment of the present invention;

FIG. 2 is an exploded perspective view thereof;

FIG. 3 is a sectional view thereof taken along line 3-3 in FIG. 1; and

FIG. 4 is a sectional view of a second embodiment of the culinary smoker.

### DETAILED DESCRIPTION OF THE INVENTION

The above-described drawing figures illustrate the invention, a culinary smoker for adding smoke flavor to food items.

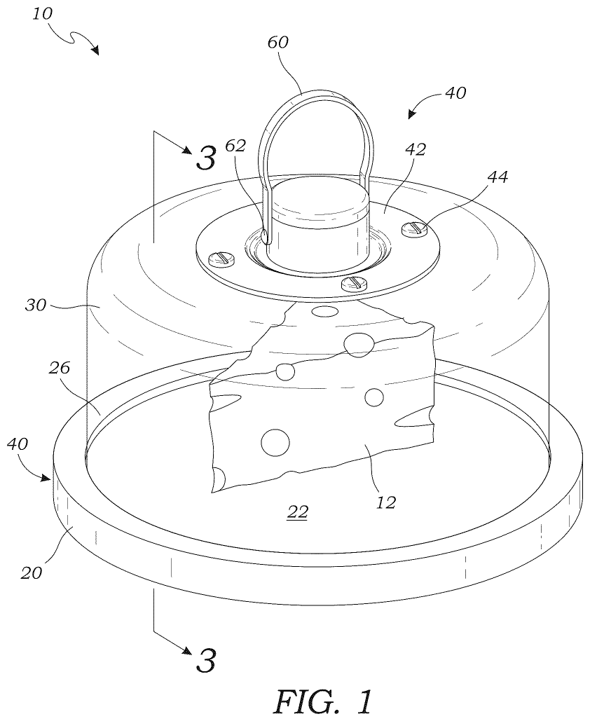

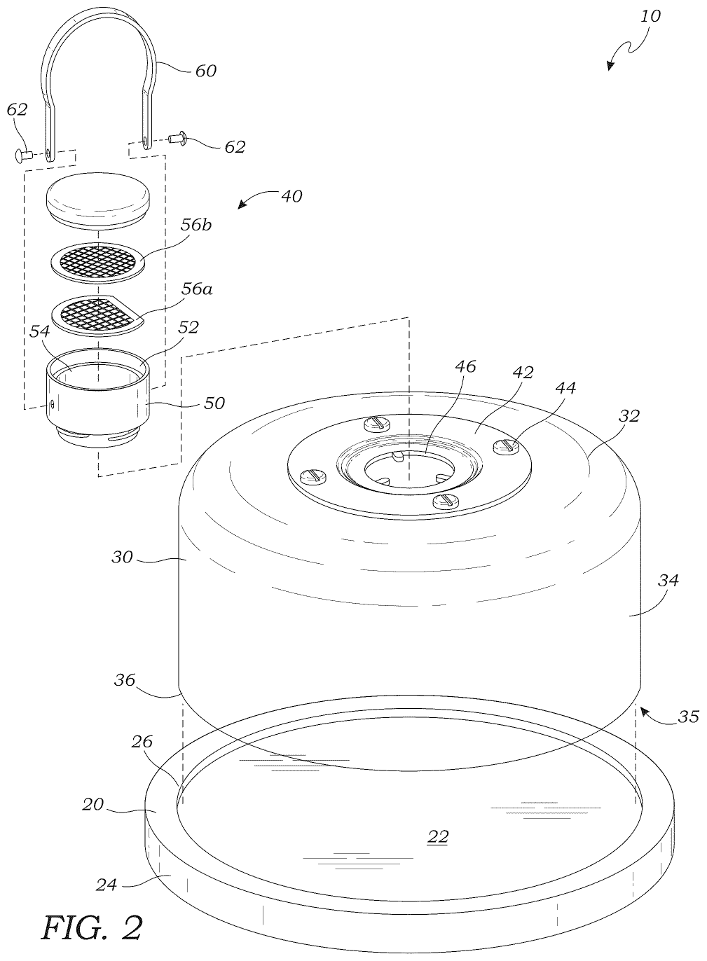

FIG. 1 is a perspective view of a culinary smoker 10 according to one embodiment of the present invention and showing a food item 12 inside the culinary smoker 10, and FIG. 2 is an exploded perspective view thereof, without the food item 12. As shown in FIGS. 1-2, the culinary smoker 10 comprises a base 20, a dome 30, and a chimney assembly 40 mounted on the dome 30. Each of these components is discussed in greater detail below. The culinary smoker 10 aids in adding smoke flavor to food items, liquor, specialty beverages, and any other items to which a user might want to add smoke flavor.

In this embodiment, the base 20 has an upwardly facing support surface 22 that extends to a perimeter 24. In this embodiment, the base 20 may be in the form of a generally planar body, and in this case is round, forming a disk shape; however, in alternative embodiments, different shapes may be used, so long as the base 20 is configured to support the food item 12.

The perimeter 24 of the base 20 may include an outer rim 26 that is raised above the rest of the base 20, which may aid in correctly positioning the dome 30 on the base 20, and assisting with creating a stable seal with the dome 30 when it is positioned on the base 20. In some embodiments, the base 20 may alternatively include a groove or alternative structure known in the art for providing these features. The base 20 may be constructed of any suitable material, e.g., wood, glass, metal, plastic, resin, etc.

In this embodiment, the dome 30 comprises a top portion 32 having a downwardly extending sidewall 34 that extends downwardly to a lower edge 36 which contacts the base 20 and abuts the inside of the outer rim 26. The top portion 32 and the sidewall 34 define an interior 35 that functions for trapping and retaining smoke, as discussed below. In this embodiment, the dome 30 is generally round in cross section, forming a generally hemispherical shape, but the term “dome” is hereby defined to include any form of cap or cover, regardless of the particular geometric shape, so long as it functions to contain the smoke as described herein.

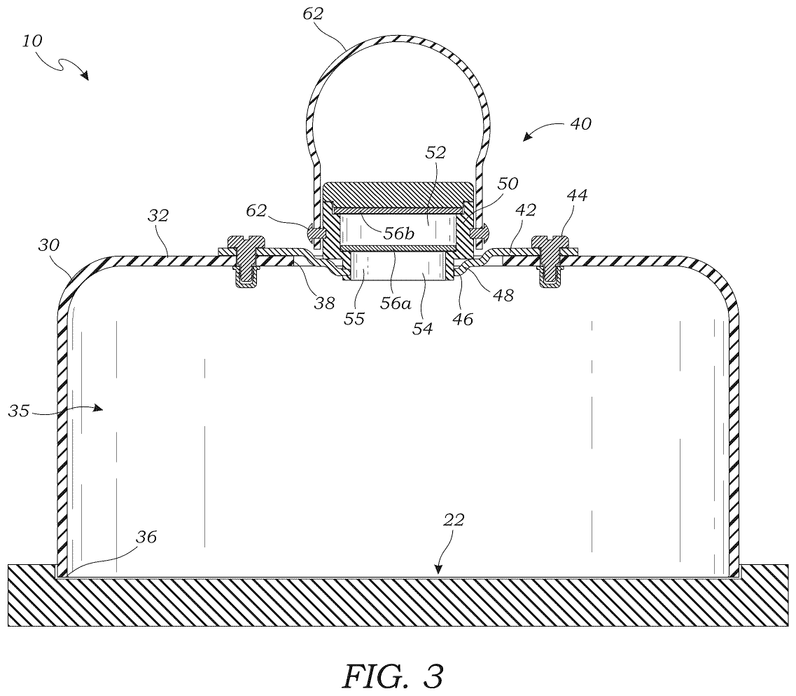

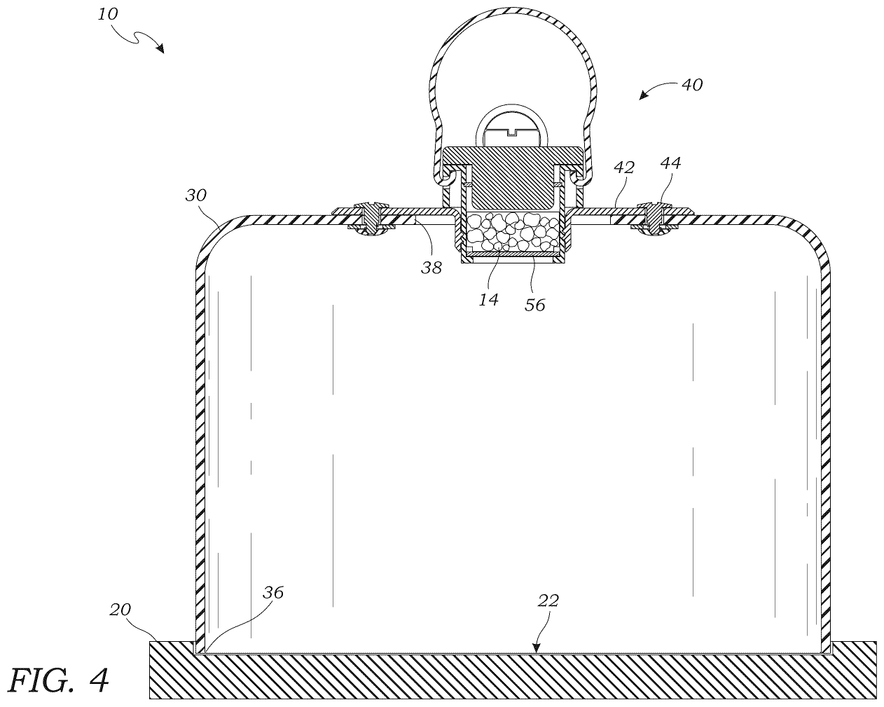

The top portion 32 of the dome 30 further includes an opening 38 (best shown in FIGS. 3-4) for receiving the chimney assembly 40, discussed below. In one embodiment, the dome 30 is constructed of borosilicate glass, or some other transparent material, which enables viewing the smoke. However, the dome 30 may be constructed of any materials suitable for containing smoke, as determined by one skilled in the art. Furthermore, in some embodiments, the top portion 32 and/or the lower edge 36 may form shapes other than generally circular (e.g., rectangular, etc.), as long as a consistent connection with the outer rim 26 of the base 20 is ensured. In the case that the base 20 does not include the outer rim 26, the lower edge 36 merely needs to fit within the perimeter 24 on the support surface 22, wherein a seal is created by the weight of the dome 30 and the chimney assembly 40. Alternatively, the support surface 22 may include a groove for receiving the lower edge 36 of the dome 30. For the purposes of this application, the term “seal” is defined to include any contact that blocks enough smoke from escaping so that the given beverage/food item 12 receives flavor, but does not necessarily form a perfect hermetic seal.

FIG. 3 is a sectional view of the culinary smoker 10 taken along line 3-3 in FIG. 1. As shown in FIGS. 1-3, the chimney assembly 40 includes a mounting plate 42 fastened to the top portion 32 of the dome 30 via a plurality of fasteners 44, the fasteners 44 being best shown in FIG. 3 and discussed in greater detail below. In this embodiment, the mounting plate 42 is generally circular and includes an aperture 46 which in this embodiment is centrally located and that concentrically aligns with the opening 38 (see FIG. 3) of the dome 30 when the mounting plate 42 is mounted on the dome 30. In this embodiment, the central aperture 46 is located in a recessed portion 48 of the mounting plate 42, wherein the recessed portion 48 of the mounting plate 42 engages a tubular chimney housing 50 of the chimney assembly 40.

In this embodiment, the mounting plate 42 may be constructed of a material that is a poor conductor of heat, such as stainless steel, and functions to prevent heat transfer from the chimney assembly 40 to the dome 30. The mounting plate 42 also enables the chimney to be removed from the dome 30, for cleaning.

In some embodiments, however, the mounting plate may be omitted from the chimney assembly 40, and the chimney housing 50 may be mounted directly to the dome 30. Various alternative embodiments may be devised, and should be considered within the scope of the invention as claimed.

In some embodiments, the chimney housing 50 includes an upper portion 52 and a lower portion 54. In some embodiments, the upper portion has a larger diameter than the lower end, which has a smaller diameter. The chimney housing 50 houses at least one screen 56 (shown in FIG. 2), in this case it may further include a first screen 56a and a second screen 56b.

A cap 58 is adapted to be removably mounted to the upper portion 52, and a handle 60 is secured to the outside of the upper portion 52, below the cap 58, for installing or removing the chimney assembly 40 from the central aperture 46. The cap 58 and the handle 60 are each discussed in greater detail below. In an assembled configuration, the upper portion 52 of the chimney housing 50 sits atop the recessed portion 48 of the mounting plate 42, wherein the lower portion 54 is smaller in diameter than the upper portion 52, and extends downwardly to engage with the recessed portion 48 of the mounting plate 42. In some embodiments, the lower portion 54 may include threads 57 (e.g., grooves, notches, etc.), for engaging with the mounting plate 42. These threads 57 may be oriented toward a “twist lock” fit, or may be more plural to “screw in” further. Alternatively, the chimney housing 50 may engage the mounting plate 42 via a bayonet-style mechanism. In this embodiment, the attachment of the chimney housing 50 to the mounting plate 42 may be performed by hand, without the need for additional tools.

As shown in FIG. 3, the mounting plate 42 is fastened to the top portion 32 of the dome 30 via the plurality of fasteners 44. In this embodiment, the fasteners 44 are in the form of screws that pass through the mounting plate 42 and the top portion 32 of the dome 30, wherein the screws are secured with nuts. Other types of fasteners may be used, e.g., pins, hooks, bolts, an adhesive, etc., and the illustrated embodiment is intended only for the purpose of example.

As shown in FIGS. 1-3, in this embodiment, the chimney housing 50 includes an inner conduit 55 having the at least one screen 56 for supporting a flammable material 14 (illustrated in FIG. 4) and allowing smoke to pass therethrough. In this embodiment, the at least one screen 56 is in the form of a first screen 56a and a second screen 56b. The first screen 56a is placed within the inner conduit 55, wherein the flammable material 14 is placed on top of the first screen 56a. The second screen 56b may then be placed on top of the flammable material 14, or instead serve as a double-filter beneath the flammable material 14. As illustrated, the second screen 56b may include a flattened edge, which may assist a user in removing it from the inner conduit 55 by hand. In various embodiments, the screen(s) 56 may be in the form of a wire mesh, but alternatively may be in the form of a solid sheet having holes formed therethrough, or similar. In some embodiments, the chimney housing 50 is constructed of a stainless steel material, which may help to reduce staining/burning, and enable ease of cleaning. The screens 56 may be removably or fixedly mounted within the chimney housing 50, as deemed suitable by one skilled in the art.

In this embodiment, the handle 60 is hingeably attached to the outside of the chimney housing 50 via a pair of pins 62, but the handle 60 may be attached via any suitable means, another example being shown in FIG. 4 and discussed below. The handle 60 may be formed in an inverted “U” shape, which may enhance ergonomic handling. For example, the handle 60 may be used to twist the chimney housing 50 so that the lower portion 54 dis/engages with the mounting plate 42.

As shown in the Figures, the cap 58 is adapted to form a seal over the top of the chimney housing 50 to retain smoke once the flammable material 14 has been ignited. The cap 58 may include a lower silicone seal for engagement with the chimney housing 50. However, any suitable alternative materials may be used. The cap 58 may be used to retain smoke, and also may be used to quickly extinguish flames by blocking the flow of oxygen. Another example of the cap 58 is shown in FIG. 4.

FIG. 4 is a sectional view of a second embodiment 70 of the culinary smoker 10. As shown in FIG. 4, in this embodiment, the cap 58 of the chimney assembly 40 includes a hingeable ear-handle 72 for removing or twisting the cap 58 within the chimney housing 50. The cap 58 may also include a downwardly extending portion 74 that has a diameter which is smaller than the diameter of the rest of the cap 58, such that the downwardly extending portion 74 passes into the inner conduit 55 of the chimney housing 50 while the rest of the cap 58 abuts the top of the chimney housing 50. This may help to form a seal for containing smoke within the chimney housing 50/dome 30, and/or it may replace the second screen 56b of the first embodiment 10. In this embodiment, the inner conduit 55 is deeper than in the first embodiment, which may help prevent debris from entering the dome 30.

FIG. 4 further shows the chimney housing 50 having a downwardly extending flange 76 that extends downwardly from the top of the chimney housing 50. In this embodiment, the handle 60 includes hooked ends 78 which pass through holes 79 in the downwardly extending flange 76, such that the handle 60 is hingeably secured to the chimney housing 50.

As illustrated, in this embodiment, the fasteners 44 that secure the mounting plate 42 to the dome 30 is in the form of binding screws and binding posts. Other types of fasteners may be used, either mechanical or non-mechanical and these should be considered within the scope of the present invention.

At a first step of using the culinary smoker 10, the beverage or food item 12 is placed on the support surface 22 of the base 20, and the dome 30 is placed over the base 20. The mounting plate 42 may be mounted to the dome 30 before or after this step. Next, the chimney housing 50 is operably attached to the mounting plate 42 using the handle 60, and the cap 58 is removed for accessing the inner conduit 55. At this point, a flammable material 14 (e.g., wood chips, etc.) is placed inside the inner conduit 55 so that it is supported by the first screen 56a, typically about ltbsp. The flammable material 14 may be ignited via any means, e.g., a standard lighter, torch, matches, etc., as long as smoke is created. In one example, a butane torch is held to wood chips for approximately 20 seconds.

Once the flammable material 14 is ignited, the smoke will begin to flow into the dome 30 to flavor the beverage/food item 12. Normally, debris and sparks fly up from the flammable material 14, but the second screen 56b may serve as a protectant from this. Furthermore, the diameter of the mounting plate 42 may catch any escaped debris so that it does not land on the glass. The cap 58 may also be replaced to extinguish the flame and contain the smoke. The user may allow the smoke to infuse with the beverage/food item 12 for any desired length of time, which may typically be in the range of 1-15 min. The glass material of the dome 30 may be resistant to becoming overheated as a result of the flame.

To stop the smoking process, the dome 30 may be removed all at once, or the cap 58 may be removed for a slower escape of smoke. The screen(s) 56 of the chimney assembly 40 may be especially useful for preventing ash or debris from falling onto the beverage/food item 12. Once smoking is completed, the beverage/food item 12 may be removed from the culinary smoker 10, wherein the separable, stainless steel components will enable ease of cleaning for re-use. Any non-electronic components may be machine-washable, further enabling ease of cleaning.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A culinary smoker for imparting smoke flavor to food and beverage items from a flammable material, the culinary smoker comprising:
a base having a support surface extending to a perimeter;
a dome including a top portion and a downwardly extending sidewall which define an interior, the downwardly extending sidewall terminating at a lower edge for contacting the base, the dome being configured to cover part of the base and form at least a partial seal therewith;
a dome aperture through the dome; and
a chimney assembly mounted to the dome, the chimney assembly including a chimney housing that includes a tubular body having a screen mounted within configured for supporting the flammable material while allowing smoke to pass through the screen, through the dome aperture, and into the interior of the dome.

2. The culinary smoker of claim 1, wherein the base includes an outer rim which extends upwardly from the support surface to abut the lower edge of the dome.

3. The culinary smoker of claim 1, wherein the dome is constructed of a transparent material to enable viewing smoke within the dome.

4. The culinary smoker of claim 1, wherein the chimney assembly further comprises a cap adapted to removably mount to the top of the chimney housing for retaining smoke within the dome.

5. The culinary smoker of claim 1, further comprising a rigid handle pivotally attached to the chimney housing for facilitating moving the dome onto and off of the base.

6. A culinary smoker for imparting smoke flavor to food and beverage items from a flammable material, the culinary smoker comprising:
a base having a support surface extending to a perimeter;
a dome including a top portion and a downwardly extending sidewall which define an interior, the downwardly extending sidewall terminating at a lower edge for contacting the base, the dome being configured to cover part of the base and form at least a partial seal therewith;
a dome aperture through the dome; and
a chimney assembly mounted to the dome and extending through the dome aperture, the chimney assembly including a mounting plate which includes a plate aperture, the mounting plate being mounted adjacent the dome aperture, the chimney assembly further including a chimney housing that includes a tubular body that extends through the plate aperture and the dome aperture, wherein the chimney housing further includes at least one screen mounted within the tubular body of the chimney housing configured for supporting the flammable material while allowing smoke to pass through to the interior of the dome.

7. The culinary smoker of claim 6, wherein the base includes an outer rim which extends upwardly from the support surface to abut the lower edge of the dome.

8. The culinary smoker of claim 6, wherein the dome is constructed of a transparent material to enable viewing smoke within the dome.

9. The culinary smoker of claim 6, wherein the chimney assembly further comprises a cap adapted to removably mount to the top of the chimney housing for retaining smoke within the dome.

10. The culinary smoker of claim 6, wherein the at least one screen comprises a first screen for supporting the flammable material and a second screen for protecting against debris and sparks.

11. The culinary smoker of claim 6, further comprising a rigid handle pivotally attached to the chimney housing for facilitating moving the dome onto and off of the base.

12. The culinary smoker of claim 6, wherein the mounting plate is constructed of stainless steel to limit heat transfer from the chimney to the dome.

13. A method for imparting smoke flavor to food and beverage items, the method comprising the steps of:
providing a culinary smoker comprising:
a base having a support surface extending to a perimeter;
a dome configured to cover part of the base and form at least a partial seal therewith, the dome including a top portion and a downwardly extending sidewall terminating at a lower edge for contacting the base;
a dome aperture through the dome; and a chimney assembly mounted to the dome, the chimney assembly including a mounting plate which includes a plate aperture, the mounting plate being mounted over the dome aperture, the chimney assembly further including a chimney housing that includes a tubular body that extends through the plate aperture, wherein the chimney housing further includes at least one screen for supporting the flammable material and allowing smoke to pass therethrough to an interior of the dome;
placing the food or beverage item on the support surface of the base of the culinary smoker;
covering the base with a dome; and
placing the flammable material on the at least one screen within the chimney housing; and
igniting the flammable material to generate smoke such that the smoke flows into the dome to infuse flavor into the food or beverage item.

14. The method of claim 13, wherein the step of igniting the flammable material includes using a butane torch to ignore the flammable material.

15. The method of claim 13, further comprising the step of extinguishing the flame and containing the smoke by placing a cap on top of the chimney housing.

16. The method of claim 13, wherein the step of allowing the smoke to infuse flavor into the food or beverage item includes a duration in the range of 1-15 minutes.

17. The method of claim 13, further comprising the step of removing the dome to stop the smoking process and allow a slower escape of smoke.
